(19) United States
(12) Patent Application Publication
(10) Pub. No.: US 2024/0250635 A1
(43) Pub. Date: Jul. 25, 2024

(54) SUNSHADE

(71) Applicants: ADIWATT, Fontaine-Raoul (FR); ZELIN, Toulouse (FR)

(72) Inventors: Mathieu NIVOCHE, St Firmin des Prés (FR); Stéphane DAVOUST, Veigné (FR); Julien SENTER, TOULOUSE (FR); Julien VITET, TOULOUSE (FR); Simon POLETTI, TOULOUSE (FR)

(21) Appl. No.: 18/237,922

(22) Filed: Aug. 25, 2023

(30) Foreign Application Priority Data
Jan. 20, 2023 (EP) 23305069

(51) Int. Cl. H02S 20/30; H02S 30/20

(52) U.S. Cl. CPC H02S 20/30; H02S 30/20

(57) ABSTRACT

A sunshade, in particular for supporting photovoltaic panels, comprising a roof structure inclined so as to have an upper portion and a lower portion, and a plurality of posts for anchoring the roof structure to the ground, said posts supporting the roof structure at the upper portion, the sunshade also comprising at least one balance wall supported mechanically by at least one of the posts and extending towards another of the posts, the at least one balance wall blocking 75% or less of the surface separating these two posts.

### CROSS-REFERENCE TO RELATED APPLICATIONS

This application claims priority to European Patent Application no. EP23305069 filed on Jan. 20, 2023, the contents of which are hereby incorporated by reference.

### TECHNICAL FIELD

The present disclosure relates to a sunshade, and more particularly a sunshade having better resistance to wind.

### PRIOR ART

A sunshade is a device intended to supply shade and comprising a roof structure mounted on supports. In recent years, the use of sunshades has greatly increased, both in agriculture, for shading certain plants, and in the energy sector, the sunshades serving as overhead support for photovoltaic panels. Agrovoltaics are sometimes even mentioned when these two applications are combined.

The success of sunshades has led to their installation in areas subjected to high winds. The sunshades then necessitate heavy ground anchorages, which is not desirable either in terms of ease of installation or in terms of ground occupancy or in terms of costs. There is therefore a need for a new type of sunshade.

### SUMMARY

To this end, the present disclosure relates to a sunshade, in particular for supporting photovoltaic panels, comprising a roof structure, inclined so as to have an upper portion and a lower portion, and a plurality of posts for anchoring the roof structure to the ground, said posts supporting the roof structure at the upper portion, the sunshade also comprising at least one balance wall supported mechanically by at least one of the posts and extending towards another of the posts, the at least one balance wall blocking 75% or less of the surface separating these two posts.

As the case may be, the roof structure may be configured to receive the photovoltaic panels. For example, the roof structure may comprise dedicated attachment means. The roof structure may comprise structural elements configured to assume the forces exerted on the sunshade and to ensure its mechanical strength, such as a purlin or a crossbeam, and non-structural elements such as attachment means for photovoltaic panels, typically rails.

Opposite the roof structure, the posts may have one end towards the ground, sometimes called the post foot. This end is free. Anchoring to the ground, typically by this free end, may be direct or indirect, for example by means of masonry, blocks set on the ground, etc. The anchoring is such that the lower portion of the roof structure is at a distance from the ground, and the upper portion is farther from the ground than the lower portion. The ground may be a natural or prepared portion, at the same level as the surrounding land, or formed by a slab of a building, raised or not, typically a parking lot or roof-terrace slab.

The roof structure extends between a high end and a low end. The upper portion, supported by the posts, extends from the high end in the direction of the low end. Conversely, the lower portion, which may be free, extends from the low end in the direction of the high end.

The at least one balance wall being supported mechanically by at least one of the posts, the balance wall is able to transmit the forces applied to it to this post, independently of the manner in which the balance wall is attached to this post or to the path followed by the forces that are transmitted.

The at least one balance wall blocks 75% or less of the surface separating the post by which it is mechanically supported, and another post toward which it extends. This proportion of blocked surface is also called the blocking ratio.

In the case where several balance walls are provided, the blocking ratio is calculated as the proportion of the surface between the two posts which is blocked by at least one balance wall. The blocking ratio may be expressed as the ratio of the blocked surface between the two posts to the total surface between the two posts. It is therefore understood that, in the above case, at least 25% of the surface separating the post by which the balance wall is mechanically supported and another post toward which it extends is not blocked, i.e. leaves free passage to the wind. In still other terms, at least 25% of said surface is perforated (openwork).

In addition, at the edge of the sunshade, a balance wall may be supported mechanically by a post and extend toward the outside of the sunshade. The surface blocked by this balance wall outside the sunshade may be added, for the calculation of the blocking ratio, to the blocked surface on the other side of the post in question.

If the sunshade comprises more than two posts, the blocking ratio is defined, as above, as the ratio of the sum of the surfaces blocked by at least one balance wall to the sum of the surfaces separating all the posts of the sunshade. In other words, the blocking ratio corresponds to an average or overall blocking ratio on the entire sunshade, as opposed to a local blocking ratio which would be calculated solely between two consecutive posts. Note that, when the sunshade comprises more than two posts, the local blocking ratio may vary from one pair of consecutive posts to another, although the criterion of an overall blocking ratio less than or equal to 75% remains satisfied. Examples will be provided hereafter.

In the present disclosure, unless otherwise stated, what is meant by “one” or “the” element (for example a post, balance wall, etc.), is “at least one” or “the at least one” or even “each” element. Reciprocally, the generic use of the plural may include the singular.

Due to the fact that the posts support the roof structure at the upper portion and that the at least one balance wall blocks 75% or less of the surface separating the post by which it is mechanically supported and another post toward which it extends, the effects of wind on the sunshade are attenuated. In fact, when the wind blows from the side of the upper portion toward the side of the lower portion, the effect of the wind on the roof structure generally creates a principal moment at the anchoring point (for example on the ground) which tends to tilt the sunshade toward the side of the upper portion. However, the impact of the wind on the balance wall creates simultaneously, at the anchoring point, an opposite moment which tends to tilt the sunshade toward the side of the lower portion and therefore compensates, at least in part, the principal moment. A similar phenomenon occurs when the wind blows in the opposite direction, the direction of each moment being reversed. In both cases, the balance wall is configured to reduce the resulting moment at the anchoring point under the influence of the wind, so that the resulting moment at the anchoring point can be significantly weaker than in the absence of a balance wall, it being noted that a blocking ratio greater than 75% would cause excessive compensation of the principal moment.

The proposed sunshade therefore relies on the counter-intuitive idea that by adding a wall having a certain wind load, the bending moment at the foot of the post, and more generally the sensitivity of the entire sunshade to the wind, can be reduced. Consequently, anchoring of the sunshade to the ground can be dimensioned in a less penalizing manner, including in regions with strong winds. The results are gains in facility of installation, ground occupancy and costs.

In some embodiments, the balance wall extends from one of the posts to another of the posts. In particular, the balance wall may be attached to each of said posts. Alternatively or additionally, the balance wall may comprise means for its attachment to the ground, such as tethers or the equivalent.

In some embodiments, the balance wall is attached at a side of the posts opposite to the side where the lower portion extends. Alternatively, the balance wall may be attached on the same side as the lower portion, or even across a post.

In some embodiments, the balance wall is provided at a distance from at least one of the ends of the posts between which it extends, preferably at a distance from both ends. In other words, the balance wall may be provided at a distance from the low end (end for anchoring to the ground) of a post, from the high end (supporting the roof structure) of a post, or from both.

In some embodiments, the balance wall could extend from both ends of the posts. In this case, a blocking ratio less than or equal to 75% may be obtained by one or more perforations of the balance wall, for example.

In some embodiments, the balance wall blocks 70% or less of the surface separating said two posts, preferably 60% or less, preferably 50% or less, preferably 40% or less, preferably 30% or less, preferably 20% or less. Thus at least 30%, preferably at least 40%, preferably at least 50%, preferably at least 60, preferably at least 70%, preferably at least 80% of said surface is not blocked, that is also to say is perforated.

In some embodiments, the balance wall blocks at least 2% of the surface separating said two posts, preferably at least 5%, preferably at least 7%, preferably at least 10%, preferably at least 15%, preferably at least 20%. Thus, at most 98% of said surface, preferably at most 95%, preferably at most 93%, preferably at most 90%, preferably at most 85%, preferably at most 80%, is not blocked, that is also to say is perforated.

In some embodiments, the lower portion of the roof structure extends as a cantilever relative to the posts. Thus, the low end of the roof structure is a free end, and the lower portion may be unsupported by the posts other than via the upper portion. The effect of the balance wall is all the more advantageous in such configurations.

In some embodiments, the posts are arranged in a single row. This row may extend transversely to the direction connecting the upper portion and the lower portion of the roof structure.

In some embodiments, the height of the balance wall is comprised between 2% and 100% of the height of the posts, preferably between 20% and 90%, more preferably between 40% and 80%. The height direction may be measured along the posts.

In some embodiments, the distance between the balance wall and the free end of the posts is comprised between 0% and 98% of the height of the posts. The free end of the posts is the end intended to be anchored to the ground, thus the distance between the balance wall and the free end of the posts is representative of the distance from the balance wall to the ground, excluding the anchoring device.

In some embodiments, the balance wall extends at most within the upper third, optionally within the upper fourth, of the height of the posts. Thus a space remains accessible below the balance wall, for example a circulation space for vehicles or pedestrians, or even a growth space for plants.

In some embodiments, in projection onto the posts, the lower portion is located at two meters at least, preferably two meters and a half at least, from the free end of the posts.

In some embodiments, the roof structure forms an angle strictly greater than 0° and less than or equal to 90° with the posts. More precisely, the angle may be comprised between 60° and 90°, perhaps between 65° and 87°.

In some embodiments, the balance wall is vertical. Alternatively or in addition, the balance wall may extend in the same direction as the posts.

In particular, the balance wall may be inclined relative to the vertical, by an angle comprised strictly between 0° and 90º. In particular, the balance wall may be inclined in the reverse direction from the direction of inclination of the roof structure, relative to the posts. According to one example, several inclined balance walls may be arranged as a louver. Moreover, the balance wall may have a variable angle of inclination depending on the wind that is blowing against this balance wall. The variable angle of inclination may be restricted by at least one stop.

### BRIEF DESCRIPTION OF THE DRAWINGS

Other features and advantages of the object of the present disclosure will be revealed by the following description of embodiments, given by way of non-limiting examples with reference to the appended figures.

FIGS. 1A-1D show schematically several sunshade configurations, viewed from the side.

FIG. 2A, FIG. 2B, FIG. 2C, FIG. 2D, FIG. 2E, FIG. 2F, FIG. 2G, FIG. 2H, FIG. 2I, FIG. 2J, FIG. 2K, FIG. 2L, FIG. 2M and FIG. 2N show, in front view, different embodiments of a balance wall for a sunshade with several spans.

FIG. 3A, FIG. 3B, FIG. 3C, FIG. 3D, FIG. 3E, FIG. 3F, FIG. 3G, FIG. 3H, FIG. 3I, FIG. 3J, FIG. 3K and FIG. 3L show, in front view, other embodiments of a balance wall, illustrated for a single span.

### DETAILED DESCRIPTION

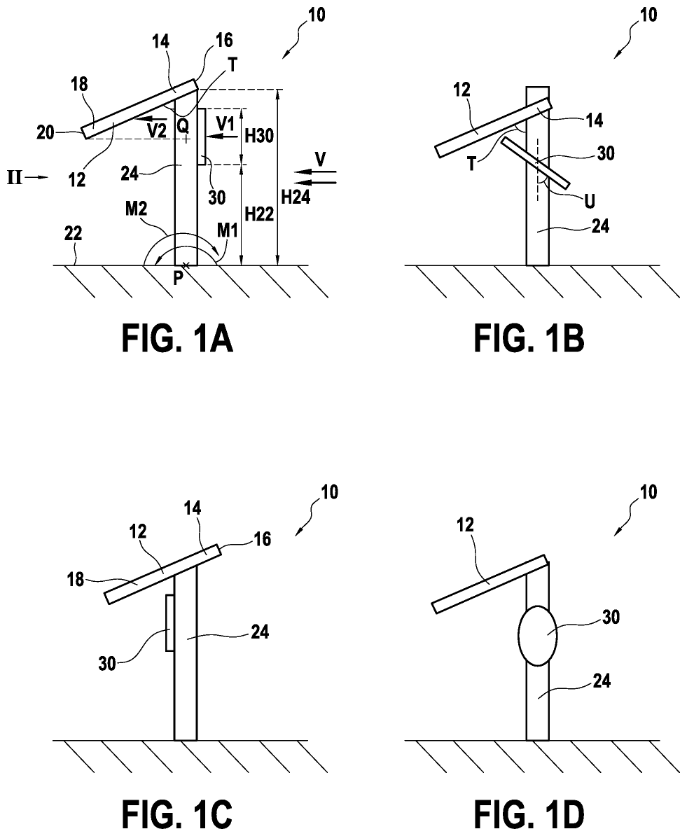

A sunshade 10 is described with reference to FIGS. 1A-1D, more particularly to FIG. 1A, according to a first embodiment.

The sunshade 10 comprises a roof structure 12 intended to provide shade. In order to take advantage of the light which reaches it, the roof structure 12 may in particular be designed to support solar panels, photovoltaic for example. The photovoltaic panels may be attached by means available to a person skilled in the art and they, as well as their attachment means, will therefore not be described per se.

The roof structure 12 may be solid or perforated; nevertheless, hereafter in the present disclosure, it is considered that the roof structure 12, possibly provided with photovoltaic panels or other desired equipment, has a certain resistance to the wind.

As revealed in FIG. 1A, the roof structure 12 is inclined so as to have an upper portion 14, which extends from a high end 16, and a lower portion 18, which extends from a low end 20. The upper portion 14 is higher than the lower portion 18 relative to the ground 22 to which the sunshade 10 in anchored. The upper portion 14 and the lower portion 18 may each represent one-half of the roof structure 12, perhaps one-third, perhaps even one-quarter.

For its anchoring to the ground, the sunshade 10 comprises a plurality of posts 24. In this particular case, the posts 24 are arranged in a single row; that is why only one of them is visible in FIGS. 1A-1D. However, several rows could be provided for. Hereafter, what is described for one post 24 may be transposed to other posts.

In this embodiment, the vertical post 24 is anchored vertically in the ground 22, but the post 24 could have other orientations. The anchoring point P is shown schematically, but a person skilled in the art knows that this anchoring point P may be implemented by means of foundations, reinforcement, counterweights or other appropriate techniques.

The post 24 supports the upper portion 14 of the roof structure 12. In this case, the upper portion 14 is attached to the high end of the post 24. FIGS. 1A-1D show a single attachment point, but the post 24 could be provided with one or more arms to support the upper portion 14 at several points. In this embodiment, the high end 16 of the roof structure 12 is supported by the post 24.

The lower portion 18 of the roof structure 12 extends as a cantilever relative to the post 24. The lower portion 18 may be free, namely on the one hand deprived of any direct support relative to the post 24, on the other hand at a distance from the ground 22. Typically, in projection on the post 24, the lower portion 18 may be located at two meters at least, preferably at least two meters and a half, from the free end of the post 24. This distance corresponds to the length of the straight-line segment [PQ] in FIG. 1A.

The roof structure 12, which is inclined, forms an angle T with the post 24. This angle T is strictly greater than 0° and less than or equal to 90°. In this case, the angle T is approximately 80°. The angle T may in particular be greater than 45°, preferably than 60°, so that the horizontal component of the roof structure 12 is greater than the vertical component. The angle T may in particular be less than 87º. Generally, the roof structure 12 may form an angle of 0° to 30° with the horizontal.

To reinforce its resistance to the wind, in particular to reduce the bending moment at the foot of the post and lighten its ground anchoring structure, the sunshade 10 also comprises at least one balance wall 30. As illustrated, the balance wall 30 is supported mechanically by a post 24, for example by being attached to this post 24. In addition, as will be seen hereafter, the balance wall 30 extends between two posts 24 so as to form an obstacle to the passage of the wind.

In the presence of a wind V, which is shown blowing from right to left in FIG. 1A, a portion V1 of the wind V which impacts the balance wall 30 generates an aerodynamic force (of the lift or downforce type). The balance wall 30 therefore transmits a corresponding force to the post 24. The post 24 being anchored in the ground, a moment M1 is created at the anchoring point P which tends to pivot the post 24 around the anchoring point, to the left (or more generally in the direction of the wind V, as illustrated in FIG. 1A). The sunshade 10 thus tends to tilt to the left. Moreover, a portion V2 of the wind V impacts the roof structure 12. The roof structure 12 being inclined, the flow of the wind around the roof structure 12 generates an aerodynamic force (of the lift or downforce type) which creates, at the anchoring point P, a moment M2 which tends to pivot the post 24 around the anchoring point P, to the right (or more generally in the opposite direction to the wind V, as illustrated in FIG. 1A). The sunshade 10 thus tends to tilt to the right.

Due to the fact that the balance wall 30 creates, at the anchoring point P, a moment M1 opposite to the principal moment M2 which has its origin in the roof structure 12, the resulting moment being applied to the post 24 relative to the anchoring point P is reduced. The moment reduction obtained relative to the principal moment M2 can, in the most unfavorable cases, reach several tens of percent.

This principle is transposed by analogy to an opposite wind V running from left to right in the figure, the generated moments M1 and M2 then being respectively in the reverse direction.

According to one example, the height H30 of the balance wall is comprised between 2% and 100% of the height H24 of the post 24, preferably between 20% and 90%, perhaps between 40% and 80%. The heights are measured in the longitudinal direction of the post 24, which corresponds to the vertical direction when the post 24 itself is vertical.

Moreover, the distance H22 between the balance wall 30 and the free end of the post, in this case the anchoring point P, is comprised between 0% and 98% of the height H24 of the posts.

According to one example, the balance wall 30 extends at most within the upper third, optionally within the upper fourth, of the height H24 of the post. In other words, the height H22 is greater than or equal to 2/3, perhaps 3/4 of the height H24 of the post 24.

As illustrated, the balance wall 30 may be provided for at a distance from at least one of the ends of the post 24, in this case at a distance from both ends. In using the preceding notations, this translates into the inequality H22+H30<H24. The balance wall 30 may be provided for entirely below the roof structure 12, but the high end of the balance wall 30 may be lower or, as illustrated, higher than the low end 20 of the roof structure 12.

As illustrated in FIG. 1A, the balance wall 30 may be arranged on a side of the post 24 opposite to the lower portion 18. Moreover, the balance wall 30 may be vertical, and more particularly parallel to the post 24. However, these features can be modified, as shown by FIGS. 1B to 1D.

FIGS. 1B to 1D show the sunshade in other embodiments. In these figures, elements corresponding to or identical with those of the embodiment of FIG. 1A will receive the same reference sign and will not be described again.

The sunshade 10 of FIG. 1B differs from that of FIG. 1A in that the roof structure 12 is not supported at one end of the post 24, but at an intermediate position on the post 24. The post 24 may therefore extend beyond the roof structure 12. However, it is indeed the upper portion 14 of the roof structure 12 which is supported by the post 24.

In addition, the balance wall 30 is not vertical, but is inclined relative to the post. More particularly, the balance wall 30 may form, with the post, an angle U greater than or equal to 0° and less than or equal to the angle T between the roof structure 12 and the post 24. The balance wall 30 can, in particular, be inclined relative to the post 24 in a direction opposite to the inclination of the roof structure 12, as illustrated in FIG. 1B.

The sunshade 10 of FIG. 1C differs from that of FIG. 1A in that the roof structure 12 is not supported at its high end 16, but more generally on its upper portion 14. Thus, the high end 16 and the low end 20 of the roof structure 12 are located on either side of the post 24.

Moreover, here the balance wall 30 is arranged on the same side of the post 24 as the lower portion 18.

The sunshade 10 of FIG. 1D differs from that of FIG. 1A in that the balance wall 30 is not planar. Here the balance wall 30 is rounded and can, to this end, have a profile that is elliptical, semi-elliptical, more generally rounded in one direction and/or in another, or any other suitable profile. A profile of this type allows accurately dimensioning the resistance to the wind of the balance wall 30.

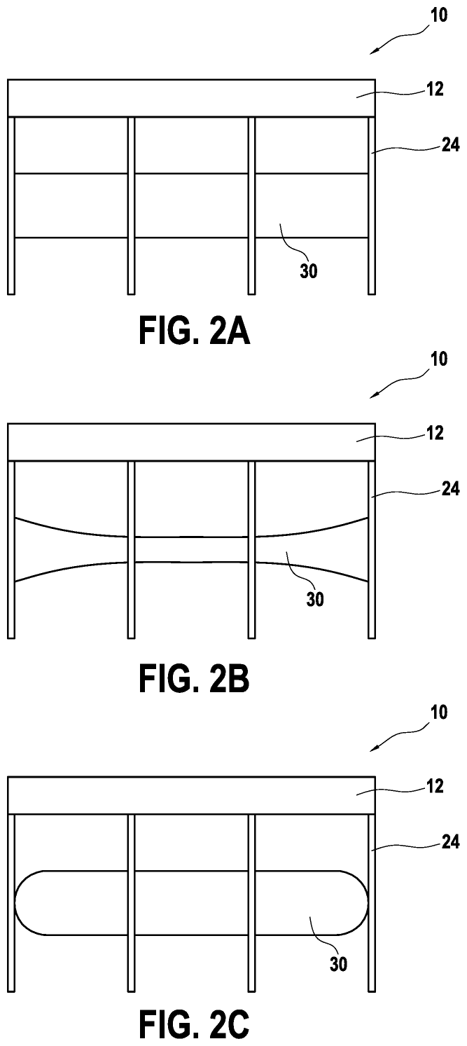

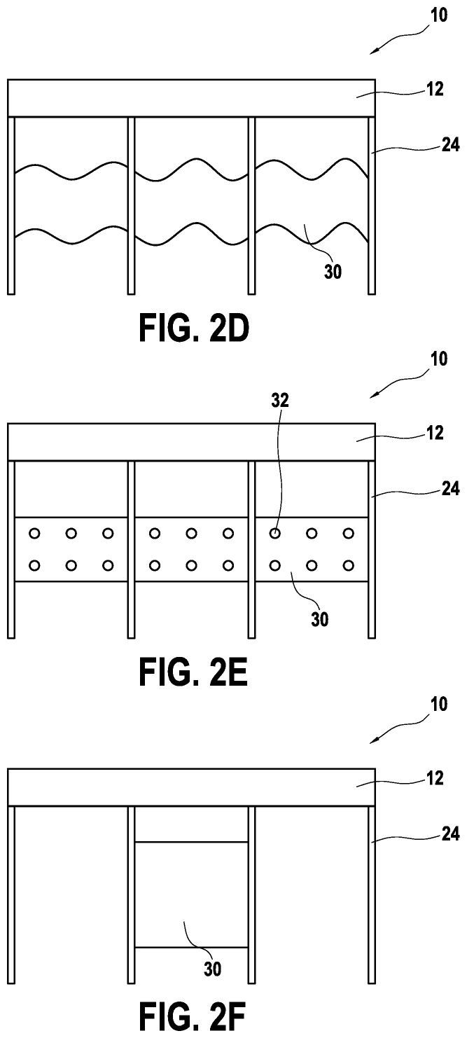

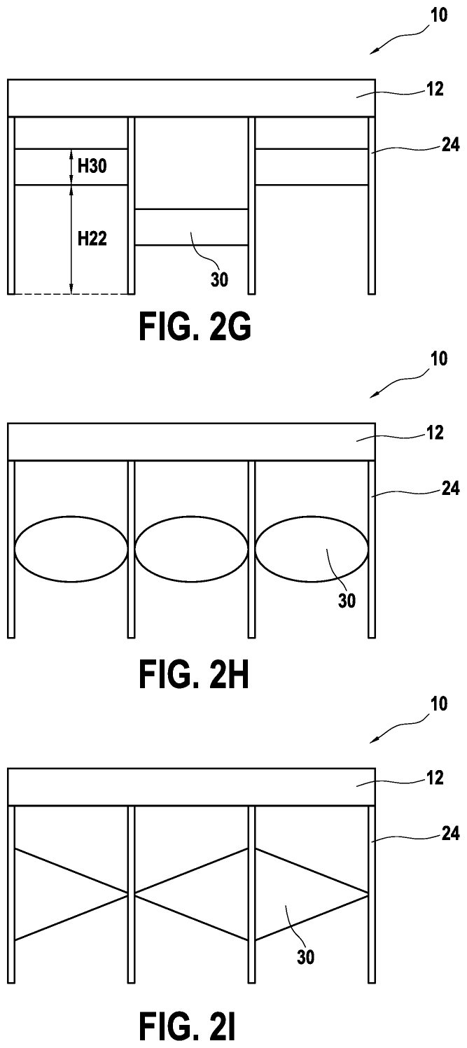

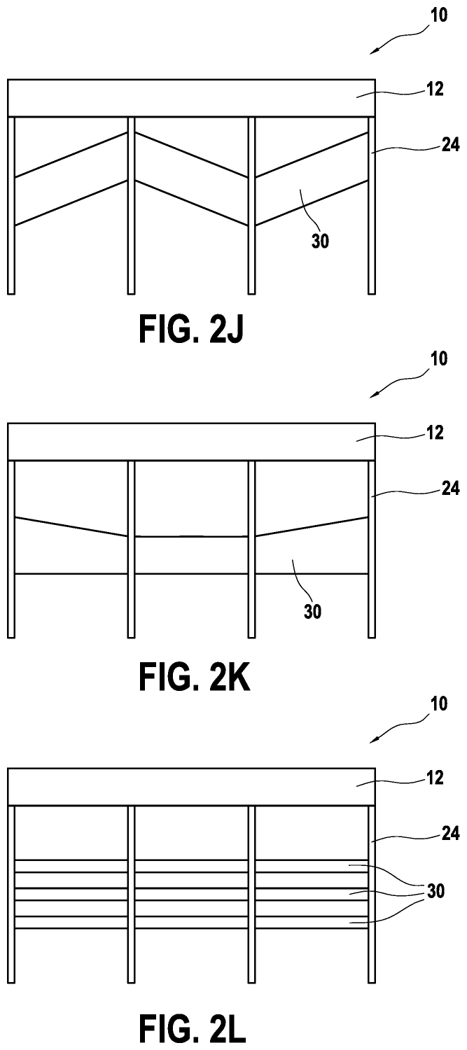

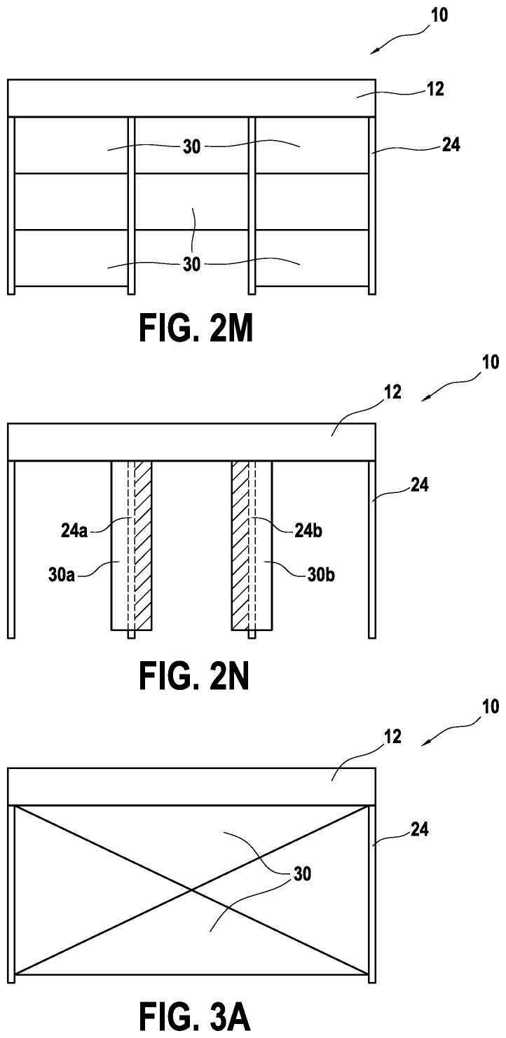

FIGS. 2A to 2M illustrate different embodiments for the balance wall 30, seen in direction II of FIGS. 1A-1D and for an example of a sunshade 10 comprising three spans defined by a row of four posts 24. However, these examples can be transposed to any other number of posts 24.

In the example of FIG. 2A, the balance walls 30 are identical from one span to another. Each balance wall 30 extends from one post 24 to an adjacent post 24. More generally, the balance wall 30 is supported mechanically by a post 24 and extends in the direction of another post. In this case, the balance wall 30 is supported mechanically by the two adjacent posts 24.

The balance wall 30 blocks 75% or less of the surface separating the post 24 which supports it from the post 24 toward which it extends. In FIG. 2A, the balance wall 30 blocks approximately one-third of this surface. In other embodiments, the maximum blocking ratios may be 70%, 60%, 50%, 40%, 30%, perhaps even 20%.

Moreover, the ratio of the frontal area of the balance wall 30 to the frontal area of the roof structure 12 may be less than or equal to 5, preferably to 4, more preferably to 3. Recall that the frontal area of a surface designates the projection of this surface onto a plane perpendicular to the flow, in this case onto the plane of the posts 24 which can be considered transverse to the flow of the wind in the most unfavorable scenarios. The aforementioned ratio may be greater than or equal to 0.01, preferably to 0.05, more preferably to 0.1.

Here the balance wall 30 has a rectangular shape and is arranged approximately at the mid-height of the posts 24.

The variant of FIG. 2B illustrates that the balance walls 30 may not be identical to one another. In addition, the shapes are not necessarily rectangular, as illustrated by the external balance walls 30, the edges of which are defined by concave curves. FIG. 2C gives the example of convex curves. In these embodiments, a continuity of shape is noted, however, from one span to another for the balance walls 30.

FIG. 2D illustrates balance walls 30, the edges of which in the height direction are defined by undulations or any other periodic function. Optionally, as illustrated, the balance walls 30 nevertheless remain identical to one another and/or continuous from one span to another.

FIG. 2E shows an example where the balance wall 30 is perforated, here due to bores 32. The bores 32 may be circular or not, and regularly arranged or not, it being specified however that a regular distribution ensures regular forces from one post 24 to another under the influence of wind.

FIG. 2F illustrates that certain spans may be provided with a balance wall 30, while others are not.

While, in the preceding embodiments, all the balance walls 30 were located at the same height, FIG. 2G illustrates that the height H22 of the balance walls 30 relative to the free end of the posts 24 may vary from one span to another. Of course, the height H30 of the balance walls may also vary, although that is not the case here.

FIG. 2H shows balance walls 30, each of them elliptical. This illustrates that the balance walls 30 may be independent from one span to another, while in other embodiments such as those of FIGS. 2B and 2C, the balance walls may be connected to one another, perhaps be formed from a single piece.

Of course, the two possibilities can be combined, as shown in FIG. 2I: a single-piece balance wall 30, for example shaped like a parallelogram or perhaps a rhombus, may extend over two spans, while another balance wall 30 is provided for the third span.

As illustrated in FIG. 2J, a given balance wall 30 may be arranged at different heights from one post 24 to another, this continuously from one span to another, as illustrated, or not. This can allow distributing forces differently from one post 24 to another.

In a relatively low position, the balance wall 30 may additionally serve as an advertising support, as a barrier or even as a support for equipment such as recharging stations for vehicles. Conversely, in a relatively high position, the balance wall 30 may additionally serve as a height limiter, as support for advertising or other things, and allow passage below it.

The example of FIG. 2K is a mixture of those of FIGS. 2A and 2J, and confirms that the features described in connection with each embodiment can be isolated and combined to form new embodiments. In this embodiment, the balance walls 30 have a trapezoidal shape.

With reference to FIG. 2L, several balance walls 30 may extend in the same span. In this case, three separate balance walls 30 are provided at different heights. The balance walls are identical in terms of shape and of dimensions and differ here only by their placement, but other variations can be contemplated.

FIG. 2M combines the principles of FIGS. 2G and 2L: by arranging a variable number of balance walls 30 in each span and varying the heights of these balance walls 30, a predetermined pattern can be created, for example a checkerboard pattern: here the balance walls 30 are arranged in alternation. Other patterns can be contemplated.

FIG. 2N illustrates the fact that, instead of being arranged in a horizontal manner overall, the balance walls 30 may be arranged in a vertical manner overall. More precisely, in this embodiment, a balance wall 30 is attached to a post 24 and protrudes beyond this post 24, on either side of this post 24. The balance wall 30 therefore extends in the direction of at least one of the adjacent posts, both of them here, without, however, reaching them.

Within a span defined between a first post 24a and a second post 24b, the blocking ratio is the sum of the blocking ratio due to the balance wall 30a attached to the first post 24a, for its portion which extends toward the second post 24b, and the blocking ratio linked to the balance wall 30b attached to the second post 24b, for its portion which extends toward the first post 24a. The useful portions of the balance walls 30a, 30b are cross-hatched in FIG. 2N.

These examples thus show that numerous variations can be contemplated.

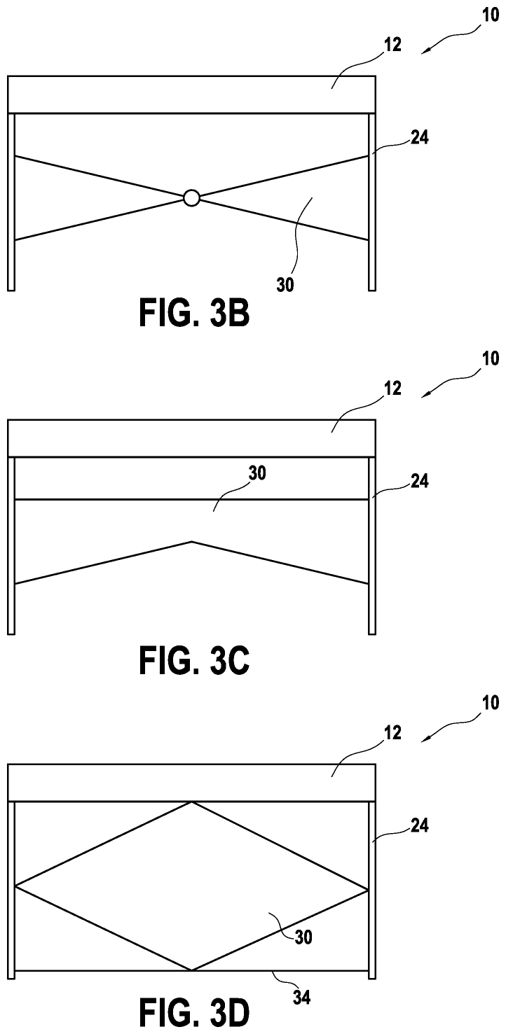

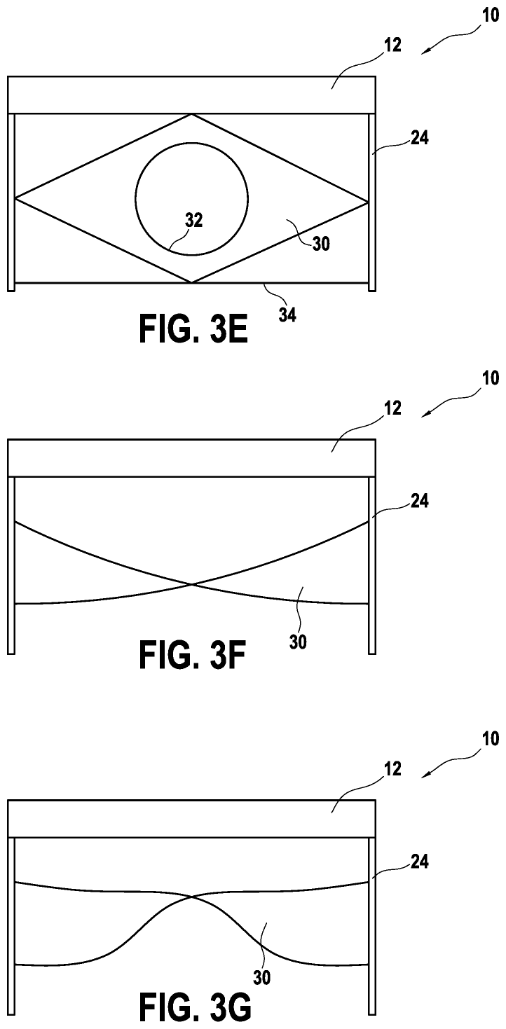

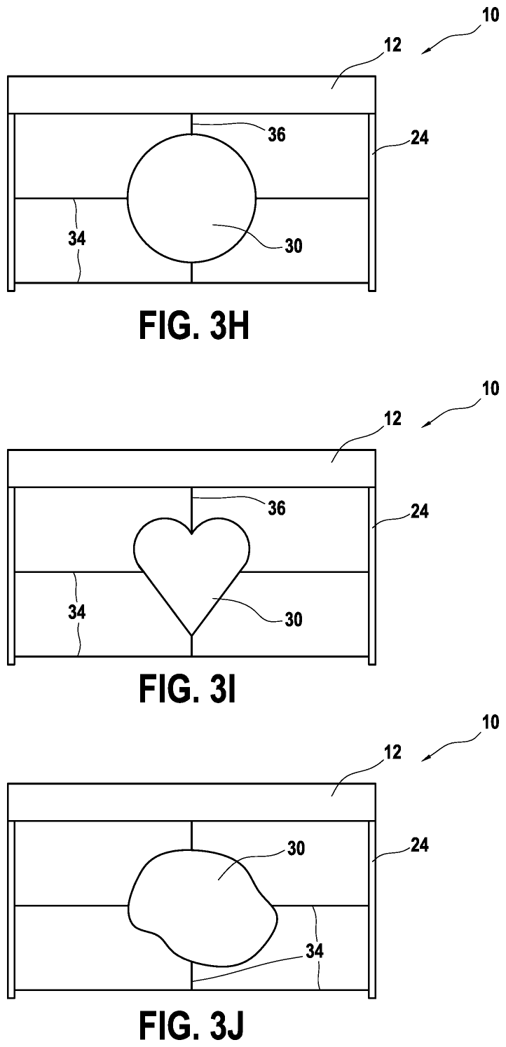

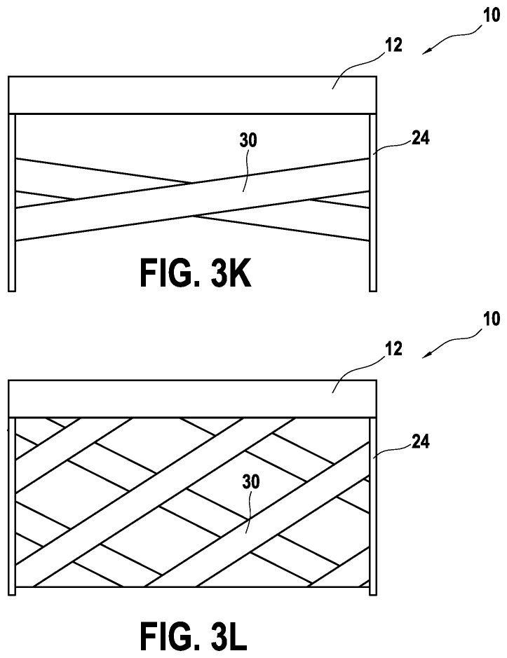

More generally, FIGS. 3A to 3L illustrate, for one span, other shapes, types and arrangements of balance wall 30. These embodiments may be extended to several spans.

For example, FIG. 3A shows two triangular balance walls 30 joined at one of their vertices, while the other vertices serve as attachment points to the posts 24, each balance wall 30 having a vertex on each post 24. Conversely, in FIG. 2B, each triangular balance wall 30 has two vertices on the same post 24.

FIG. 3C illustrates that, in addition to the rectangular, parallelogram and trapezoidal shapes seen previously, the balance wall 30 may have a more complex polygonal shape, possibly concave.

FIG. 3D shows a balance wall 30 shaped like a rhombus. When it is necessary, a support cable or beam 34 may be provided for to improve the mechanical support of the balance wall 30 by the posts 24. In this case, the support cable 34 is stretched between two posts 24, adjacent here, and the balance wall 30 is supported at least in part by this support cable 34, for example by being attached to it, perhaps simply retained on it. For example, a corner of the rhombus may be supported by the support cable 34, while two other corners are supported directly by the posts 24. A support cable 34 may be provided, not only under the balance wall 30, but also above or to one side, depending on the need. In addition, these features are transposable regardless of the shape of the balance wall 30.

The embodiment of FIG. 3E is similar to that of FIG. 3D, excepting the fact that the balance wall 30 is perforated by the presence of a bore 32.

FIGS. 3F and 3G show that the balance wall may have any desired shape, not only polygonal but curved, or a combination of both. Here in particular, the edges of the balance wall 30 may be defined by a continuous, perhaps differentiable function, a polynomial for example.

In the embodiment of FIG. 3H, the balance wall 30 is supported relative to one of the posts 24, here both posts 24, via one or more support cables or beams 34. When the wind blows on the balance wall 30, this stretches the support cables 34, which then transmit a force in the same direction to the posts 34. Thus, the balance wall 30 may not be directly in contact with the post 24, provided that its attachment allows it to nevertheless be supported mechanically by at least one of the posts 24.

Moreover, if desired, a support cable or beam 36 may mechanically connect the wall 30 to the roof structure 12, particularly to a structural element of the roof structure 12.

A support mechanism of this type offers greater design freedom for the shape of the balance wall 30. Thus, FIG. 3H shows a circular balance wall 30, but other shapes are of course possible, such as the heart shape of FIG. 3I or the arbitrary shape of FIG. 3J. In addition, the number of support cables 34 may be modified, likewise their placement and their direction. To better distribute the forces between the posts 24 and on these posts 24, it nevertheless remains desirable that the balance wall have its center of gravity centered relative to the posts 24, in width and/or in height.

Moreover, as illustrated in FIG. 3K, the balance walls 30 may be superimposed. FIG. 3L illustrates a pattern of the grid type which may be obtained by repeating the unit pattern of FIG. 3K.

Although the present description refers to specific exemplary embodiments, modifications can be applied to these examples without departing from the general scope of the invention as defined in the claims. For example, although the balance walls described are essentially planar, non-planar balance walls may also be provided for, and the designs presented above can be declined in three dimensions. More generally, individual features of the different embodiments illustrated or mentioned can be combined into additional embodiments. Consequently, the description and the drawings must be considered in an illustrative, rather than a restrictive sense.

1. A sunshade comprising a roof structure, inclined so as to have an upper portion and a lower portion, and a plurality of posts for anchoring the roof structure to the ground, said plurality of posts supporting the roof structure at the upper part, the sunshade further comprising at least one balance wall supported mechanically by at least a first post of the plurality of posts and extending towards a second post of the plurality of posts, the at least one balance wall blocking 75% or less of the surface separating the first post and the second post.

2. The sunshade according to claim 1, wherein the balance wall is provided at a distance from at least one end of the first post or the second post, optionally at a distance from both ends.

3. The sunshade according to claim 1, wherein the balance wall blocks 70% or less of the surface separating said two posts.

4. The sunshade according to claim 1, wherein the balance wall blocks 60% or less of the surface separating said two posts.

5. The sunshade according to claim 1, wherein the balance wall blocks 50% or less of the surface separating said two posts.

6. The sunshade according to claim 1, wherein the balance wall blocks 40% or less of the surface separating said two posts.

7. The sunshade according to claim 1, wherein the balance wall blocks 30% or less of the surface separating said two posts.

8. The sunshade according to claim 1, wherein the balance wall blocks 20% or less of the surface separating said two posts.

9. The sunshade according to claim 1, wherein the lower portion of the roof structure extends as a cantilever relative to the plurality of posts.

10. The sunshade according to claim 1, wherein the plurality of posts are arranged in a single row.

11. The sunshade according to claim 1, wherein a height of the balance wall is comprised of between 2% and 100% of a height of the plurality of posts.

12. The sunshade according to claim 1, wherein a height of the balance wall is comprised of between 20% and 90% of a height of the plurality of posts.

13. The sunshade according to claim 1, wherein a height of the balance wall is comprised of between 40% and 80% of a height of the plurality of posts.

14. The sunshade according to claim 1, wherein the distance between the balance wall and a free end of the plurality of posts is comprised of between 0% and 98% of a height of the plurality of posts.

15. The sunshade according to claim 1, wherein the balance wall extends at most within an upper fourth of the height of the plurality of posts.

16. The sunshade according to claim 1, wherein the roof structure forms an angle that is strictly greater than 0° and less than or equal to 90° with the plurality of posts.

17. The sunshade according to claim 1, wherein the balance wall is vertical.

18. The sunshade according to claim 1, wherein, in projection on the plurality of posts, the lower portion is located at least two meters from a free end of the plurality of posts.

19. The sunshade according to claim 18, wherein, in projection on the plurality of posts, the lower portion is located at least 2.5 meters from a free end of the plurality of posts.

20. The sunshade according to claim 1, wherein the sunshade supports photovoltaic panels.
